(19) United States
(12) Patent Application Publication
(10) Pub. No.: US 2014/0003615 A1
(43) Pub. Date: Jan. 2, 2014

(54) NOISE REDUCTION METHOD, DEVICE, AND SYSTEM

(71) Applicant: Huawei Technologies Co., Ltd., Shenzhen (CN)

(72) Inventors: Baosheng Li, Shenzhen (CN); Liqian Zhai, Shenzhen (CN); Shanjiu Chi, Shenzhen (CN)

(73) Assignee: Huawei Technologies Co., Ltd., Shenzhen (CN)

(21) Appl. No.: 13/905,325

(22) Filed: May 30, 2013

(30) Foreign Application Priority Data
Jul. 2, 2012 (CN) 201210224018.0

(51) Int. Cl. H04R 3/00

(52) U.S. Cl. CPC H04R 3/002
USPC 381/73.1

(57) ABSTRACT

Embodiments of the present invention provide a noise reduction method, device, and system. In the embodiments of the present invention, operating condition information of a noise source is obtained, where the operating condition information represents an operating condition of the noise source, then sound wave information corresponding to the obtained operating condition information is determined according to a pre-set mapping between the operating condition information and the sound wave information, and active noise reduction is performed by using the corresponding sound wave information. Steps such as collection, conversion, and calculation for noise generated by the noise source are not required, thereby shortening time for the active noise reduction.

### CROSS-REFERENCE TO RELATED APPLICATIONS

This application claims priority to Chinese Patent Application No. 201210224018.0, filed on Jul. 2, 2012, which is hereby incorporated by reference in its entirety.

### TECHNICAL FIELD

The present application relates to noise processing technologies, and in particular, to a noise reduction method, device, and system.

### BACKGROUND

When an electronic device such as a machine cabinet is normally operating, many noise sources may exist and generate noise, for example, a fan used to perform cooling treatment for the electronic device. In the prior art, an active noise reduction method may be adopted to eliminate the noise generated by the noise sources.

In the existing active noise reduction method, steps such as collection, conversion, and calculation for the noise generated by the noise sources are required, and then a sound for active noise reduction is output, which is time-consuming.

### SUMMARY

In many aspects, the present application provides a noise reduction method, device, and system, so as to solve the problem in the prior art that active noise reduction is time-consuming.

In one aspect, the present application provides a noise reduction method, including:

obtaining operating condition information of a noise source, where the operating condition information represents an operating condition of the noise source;

determining sound wave information corresponding to the obtained operating condition information according to a preset mapping between the operating condition information and the sound wave information, where the corresponding sound wave information is used to instruct a sound-making device to make a first noise reduction sound wave having an equal frequency, an equal amplitude, and a reverse phase of a noise sound wave made by the noise source in the operating condition; and

instructing the sound-making device to make the first noise reduction sound wave according to the corresponding sound wave information, so that the noise sound wave made by the noise source and the first noise reduction sound wave are superimposed, thereby reducing noise.

In the first possible implementation manner, after the instructing the sound-making device to make the first noise reduction sound wave according to the corresponding sound wave information, the method further includes:

obtaining superimposed sound wave information after the noise sound wave made by the noise source and the first noise reduction sound wave are superimposed;

adjusting the corresponding sound wave information according to the superimposed sound wave information, where the adjusted corresponding sound wave information is used to instruct the sound-making device to make a second noise reduction sound wave having an equal frequency, an equal amplitude, and a reverse phase of the noise sound wave made by the noise source in the operating condition; and

instructing the sound-making device to make the second noise reduction sound wave according to the adjusted corresponding sound wave information, so that the noise sound wave made by the noise source and the second noise reduction sound wave are superimposed, thereby further reducing noise.

In combination with the first possible implementation manner, in a second possible implementation manner, the noise source is a fan, and the obtaining operating condition information of a noise source includes:

obtaining a rotation speed of the fan and a pressure difference caused by the fan; or

obtaining a rotation speed of the fan and a current of the fan.

In combination with the first or second possible implementation manner, in a third possible implementation manner, the corresponding sound wave information includes:

a frequency, an amplitude, and a phase of the first noise reduction sound wave required to be made.

In combination with the first, second, or third possible implementation manner, in a fourth possible implementation manner, the corresponding sound wave information is direct indication information, used to directly instruct the sound-making device to make the first noise reduction sound wave having an equal frequency, an equal amplitude, and a reverse phase of the noise sound wave made by the noise source; or the corresponding sound wave information is indirect indication information, used to instruct the sound-making device to make the first noise reduction sound wave having an equal frequency, an equal amplitude, and a reverse phase of the noise sound wave made by the noise source after conversion.

In combination with the first, second, third, or fourth possible implementation manner, in a fifth possible implementation manner, before the determining sound wave information corresponding to the obtained operating condition information according to a pre-set mapping between the operating condition information and the sound wave information, the method further includes:

obtaining the mapping between the operating condition information and the sound wave information through test.

In another aspect, the present application provides a noise reduction device, including:

an obtaining unit, configured to obtain operating condition information of a noise source, where the operating condition information represents an operating condition of the noise source, and to transmit the obtained operating condition information to a determining unit;

the determining unit, configured to determine sound wave information corresponding to the operating condition information according to a pre-set mapping between the operating condition information and the sound wave information, and to transmit the corresponding sound wave information to an instructing unit, where the corresponding sound wave information is used to instruct a sound-making device to make a first noise reduction sound wave having an equal frequency, an equal amplitude, and a reverse phase of a noise sound wave made by the noise source in the operating condition; and

the instructing unit, configured to instruct the sound-making device to make the first noise reduction sound wave according to the corresponding sound wave information, so that the noise sound wave made by the noise source and the first noise reduction sound wave are superimposed, thereby reducing noise.

In the first possible implementation manner, after the instructing unit instructs the sound-making device to make the first noise reduction sound wave according to the corresponding sound wave information,

the obtaining unit is further configured to obtain the superimposed sound wave information after the noise sound wave made by the noise source and the first noise reduction sound wave are superimposed, and to transmit the superimposed sound wave information to the determining unit;

the determining unit is further configured to adjust the corresponding sound wave information according to the superimposed sound wave information, and to transmit the adjusted corresponding sound wave information to the instructing unit, where the adjusted corresponding sound wave information is used to instruct the sound-making device to make a second noise reduction sound wave having an equal frequency, an equal amplitude, and a reverse phase of the noise sound wave made by the noise source in the operating condition; and

the instructing unit is further configured to instruct the sound-making device to make the second noise reduction sound wave according to the adjusted corresponding sound wave information, so that the noise sound wave made by the noise source and the second noise reduction sound wave are superimposed, thereby further reducing noise.

In combination with the first possible implementation manner, in a second possible implementation manner, the noise source is a fan, and the obtaining unit is specifically configured to

obtain a rotation speed of the fan and a pressure difference caused by the fan; or

obtain a rotation speed of the fan and a current of the fan.

In combination with the first or second possible implementation manner, in a third possible implementation manner, the corresponding sound wave information determined by the determining unit includes:

a frequency, an amplitude, and a phase of the first noise reduction sound wave required to be made.

In combination with the first, second, or third possible implementation manner, in a fourth possible implementation manner, the corresponding sound wave information determined by the determining unit is direct indication information, used to directly instruct the sound-making device to make the first noise reduction sound wave having an equal frequency, an equal amplitude, and a reverse phase of the noise sound wave made by the noise source; or the corresponding sound wave information determined by the determining unit is indirect indication information, used to instruct the sound-making device to make the first noise reduction sound wave having an equal frequency, an equal amplitude, and a reverse phase of the noise sound wave made by the noise source after conversion.

In combination with the first, second, third, or fourth possible implementation manner, in a fifth possible implementation manner, before the determining unit determines the sound wave information corresponding to the operating condition information according to the pre-set mapping between the operating condition information and the sound wave information, the obtaining unit is further configured to

obtain the mapping between the operating condition information and the sound wave information through test, and transmit the mapping between the operating condition information and the sound wave information to the determining unit.

In still another aspect, the present application provides a noise reduction system, including a controller and a sound-making device, where:

the controller is configured to obtain operating condition information of a noise source, where the operating condition information represents an operating condition of the noise source, and to determine sound wave information corresponding to the obtained operating condition information according to a pre-set mapping between the operating condition information and the sound wave information, where the corresponding sound wave information is used to instruct a sound-making device to make a first noise reduction sound wave having an equal frequency, an equal amplitude, and a reverse phase of a noise sound wave made by the noise source in the operating condition;

the controller is further configured to send a first sound-making command to the sound-making device according to the corresponding sound wave information, where the first sound-making command is used to instruct the sound-making device to make the first noise reduction sound wave; and

the sound-making device is connected with the controller, and is configured to receive the first sound-making command, and to make the first noise reduction sound wave according to the first sound-making command, so that the noise sound wave made by the noise source and the first noise reduction sound wave are superimposed, thereby reducing noise.

In the first possible implementation manner, after the controller sends the first sound-making command to the sound-making device according to the corresponding sound wave information,

the controller is further configured to obtain the superimposed sound wave information after the noise sound wave made by the noise source and the first noise reduction sound wave are superimposed, to adjust the corresponding sound wave information according to the superimposed sound wave information, where the adjusted corresponding sound wave information is used to instruct the sound-making device to make a second noise reduction sound wave having an equal frequency, an equal amplitude, and a reverse phase of the noise sound wave made by the noise source in the operating condition, and to send a second sound-making command to the sound-making device according to the adjusted corresponding sound wave information, where the second sound-making command is used to instruct the sound-making device to make the second noise reduction sound wave; and

the sound-making device is further configured to receive the second sound-making command, and to make the second noise reduction sound wave according to the second sound-making command, so that the noise sound wave made by the noise source and the second noise reduction sound wave are superimposed, thereby reducing noise.

In combination with the first possible implementation manner, in a second possible implementation manner, the noise source is a fan, and the controller is specifically configured to

obtain a rotation speed of the fan and a pressure difference caused by the fan; or

obtain a rotation speed of the fan and a current of the fan.

In combination with the first or second possible implementation manner, in a third possible implementation manner, the corresponding sound wave information determined by the controller includes:

a frequency, an amplitude, and a phase of the noise reduction sound wave required to be made.

In combination with the first, second, or third possible implementation manner, in a fourth possible implementation manner, the corresponding sound wave information determined by the controller is direct indication information, used to directly instruct the sound-making device to make the first noise reduction sound wave having an equal frequency, an equal amplitude, and a reverse phase of the noise sound wave made by the noise source; or the corresponding sound wave information determined by the controller is indirect indication information, used to directly instruct the sound-making device to make the first noise reduction sound wave having an equal frequency, an equal amplitude, and a reverse phase of the noise sound wave made by the noise source after conversion.

In combination with the first, second, third, or fourth possible implementation manner, in a fifth possible implementation manner, before the controller determines the sound wave information corresponding to the operating condition information according to the pre-set mapping between the operating condition information and the sound wave information, the controller is further configured to

obtain the mapping between the operating condition information and the sound wave information through test.

It may be known from the above technical solution that, in the embodiments of the present application, the operating condition information of the noise source is obtained, where the operating condition information represents an operating condition of the noise source, then the sound wave information corresponding to the obtained operating condition information is determined according to the pre-set mapping between the operating condition information and the sound wave information, and active noise reduction is performed by using the corresponding sound wave information. Steps such as collection, conversion, and calculation for noise generated by the noise source are not required, thereby shortening time for the active noise reduction. In addition, the controller does not need to perform complicated calculating operations, thereby effectively lowering performance requirements for the controller.

### BRIEF DESCRIPTION OF DRAWINGS

To describe the technical solutions in the embodiments of the present application more clearly, the following briefly introduces the accompanying drawings for describing the embodiments. Apparently, the accompanying drawings in the following description show merely some embodiments of the present application, and persons of ordinary skill in the art may still derive other drawings from the accompanying drawings without creative efforts.

FIG. 1 is a schematic flow chart of a noise reduction method according to an embodiment of the present application;

FIG. 2 is a schematic structural diagram of a noise reduction device according to another embodiment of the present application;

FIG. 3 is a schematic structural diagram of a noise reduction system according to another embodiment of the present application;

FIG. 4 is a schematic structural diagram of a noise reduction system according to another embodiment of the present application;

FIG. 5 is a schematic structural diagram of a noise reduction system according to another embodiment of the present application;

FIG. 6 is a schematic structural diagram of a noise reduction system according to another embodiment of the present application;

FIG. 7 is a schematic structural diagram of a noise reduction system according to another embodiment of the present application; and

FIG. 8 is a schematic structural diagram of a noise reduction system according to another embodiment of the present application.

### DESCRIPTION OF EMBODIMENTS

To make the objectives, technical solutions, and advantages of embodiments of the present application more comprehensible, the following clearly describes the technical solutions in the embodiments of the present application with reference to the accompanying drawings in the embodiments of the present application. Apparently, the described embodiments are merely a part rather than all of the embodiments of the present application. All other embodiments obtained by persons of ordinary skill in the art based on the embodiments of the present application without making creative efforts shall fall within the protection scope of the present application.

In addition, the terms “and/or” in this document is only as an association relationship for describing the associated objects, and represents that three relationships may exist, for example, A and/or B may represent the following three cases: A exists separately, and both A and B exist, and B exists separately. In addition, the character “/” in this document usually represents that the former and the later associated objects are in a “or” relation.

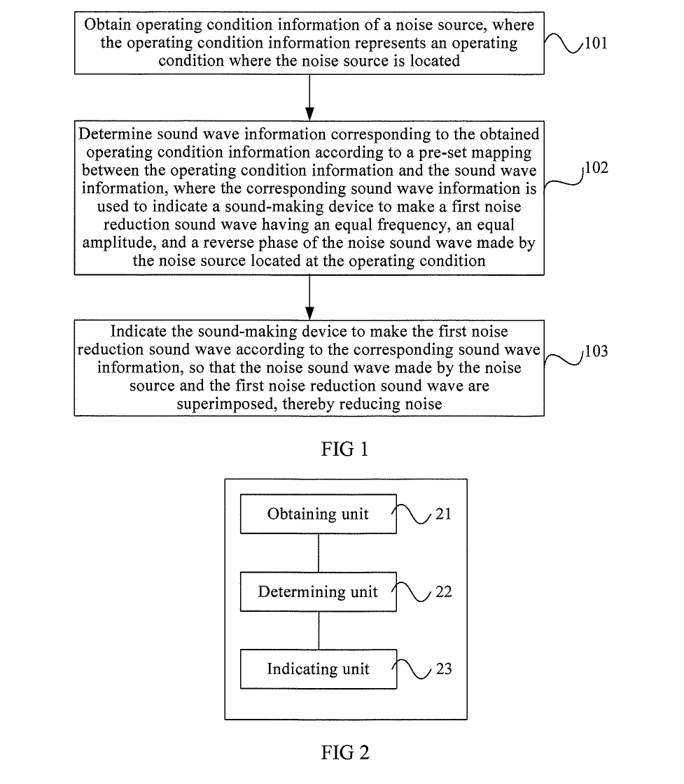

FIG. 1 is a schematic flow chart of a noise reduction method according to an embodiment of the present application, as shown in FIG. 1.

Step 101: Obtain operating condition information of a noise source, where the operating condition information represents an operating condition of the noise source.

Step 102: Determine sound wave information corresponding to the obtained operating condition information according to a pre-set mapping between the operating condition information and the sound wave information, where the corresponding sound wave information is used to instruct a sound-making device to make a first noise reduction sound wave having an equal frequency, an equal amplitude, and a reverse phase of a noise sound wave made by the noise source in the operating condition.

It should be noted that, the feature “an equal frequency, an equal amplitude, and a reverse phase” herein is not “completely equal”. Persons skilled in the art can understand that, because of the limitation of techniques and technologies, the “equal and reverse” should be “equal and reverse as far as possible” under the condition of being capable of achieving the technical effect, and cannot be understood as completely equal or reverse in an absolute manner.

Step 103: Instruct the sound-making device to make the first noise reduction sound wave according to the corresponding sound wave information, so that the noise sound wave made by the noise source and the first noise reduction sound wave are superimposed, thereby reducing noise.

In this way, the two sound waves having an equal frequency, an equal amplitude, and a reverse phase may cancel each other during superimposition, thereby achieving the function of reducing sound wave strength.

The noise source may be a fan set inside an electronic device and used to perform cooling treatment for the electronic device. The sound-making device may be a device that is capable of making sound waves, such as, a loudspeaker or a speaker box.

Optionally, in a possible implementation manner of this embodiment, after step 103, the superimposed sound wave information after the noise sound wave made by the noise source and the first noise reduction sound wave are superimposed may further be obtained; then the corresponding sound wave information may be adjusted according to the superimposed sound wave information, where the adjusted corresponding sound wave information is used to instruct the sound-making device to make a second noise reduction sound wave having an equal frequency, an equal amplitude, and a reverse phase of the noise sound wave made by the noise source in the operating condition; and the sound-making device is instructed to make the second noise reduction sound wave according to the adjusted corresponding sound wave information, so that the noise sound wave made by the noise source and the second noise reduction sound wave are superimposed, thereby further reducing noise. This step is equivalent to performing “fine-tuning” for the noise reduction sound wave, because in an actual process, the first noise reduction sound wave is generally impossible to completely meet the condition of “having an equal frequency, an equal amplitude, and a reverse phase”, fine-tuning is required to make the second noise reduction sound wave to further meet the condition of having an equal frequency, an equal amplitude, and a reverse phase, thereby further enhancing a noise reduction effect.

Optionally, in a possible implementation manner of this embodiment, if the noise source is a fan, then in step 101, a rotation speed of the fan and a pressure difference caused by the fan may be specifically obtained; or a rotation speed of the fan and a current of the fan may also be obtained, which is not limited in this embodiment.

Optionally, in a possible implementation manner of this embodiment, the corresponding sound wave information determined in step 102 may include a frequency, an amplitude, and a phase of the first noise reduction sound wave required to be made.

Optionally, in a possible implementation manner of this embodiment, the corresponding sound wave information determined in step 102 may further be direct indication information, used to directly instruct the sound-making device to make the first noise reduction sound wave having an equal frequency, an equal amplitude, and a reverse phase of the noise sound wave made by the noise source.

Optionally, in a possible implementation manner of this embodiment, the corresponding sound wave information determined in step 102 may also be indirect indication information, used to instruct the sound-making device to make the first noise reduction sound wave having an equal frequency, an equal amplitude, and a reverse phase of the noise sound wave made by the noise source after conversion.

Optionally, in a possible implementation manner of this embodiment, before step 102, the mapping between the operating condition information and the sound wave information may further be obtained through test, as shown in Table 1.

TABLE 1
Mapping between operating condition information
and sound wave information

| | | | | Sound wave |
|---|---|---|---|---|
| Operating | | Pressure | | information S (phase, |
| condition | Rotation | difference | | frequency, and |
| information | speed n | Δp | Current i | amplitude) |
| 1 | n1 | Δp1 | i1 | S1 |
| 2 | n2 | Δp2 | i2 | S2 |
| 3 | n3 | Δp3 | i3 | S3 |
| . . . | . . . | . . . | . . . | . . . |
| x | nx | Δpx | ix | Sx |

In this embodiment, the operating condition information of the noise source is obtained, where the operating condition information represents the operating condition of the noise source, then the sound wave information corresponding to the obtained operating condition information is determined according to the pre-set mapping between the operating condition information and the sound wave information, and active noise reduction is performed by using the corresponding sound wave information. Steps such as collection, conversion, and calculation for noise generated by the noise source are not required, thereby shortening time for the active noise reduction, and reducing noise reduction space. In addition, the controller does not need to perform complicated calculating operations, thereby effectively lowering performance requirements for the controller.

It should be noted that, for the methods according to the embodiments, for purposes of simplicity of explanation, the methods are described as a combination of a series of actions, but it should be clear to persons skilled in the art that the present application is not limited by the order of the actions, as some steps can, in accordance with the present application, be performed in other orders or concurrently. Next, persons skilled in the art should also know that, the embodiments described in the specification all fall within exemplary embodiments, and the related actions and modules are not necessarily required by the present application.

In the embodiments, description for the embodiments has its own emphasis, and a part without being described in detail in a certain embodiment can be obtained with reference to relevant description in other embodiments.

Based on the foregoing embodiment, another embodiment of the present application provides a noise reduction device. As shown in FIG. 2, the noise reduction device in this embodiment may include an obtaining unit 21, a determining unit 22, and an instructing unit 23.

The obtaining unit 21 is configured to obtain operating condition information of a noise source, where the operating condition information represents an operating condition of the noise source, and to transmit the obtained operating condition information to the determining unit 22; the determining unit 22 is configured to determine sound wave information corresponding to the operating condition information according to a pre-set mapping between the operating condition information and the sound wave information, and to transmit the corresponding sound wave information to the instructing unit 23, where the corresponding sound wave information is used to instruct a sound-making device to make a first noise reduction sound wave having an equal frequency, an equal amplitude, and a reverse phase of a noise sound wave made by the noise source in the operating condition; and the instructing unit 23 is configured to instruct the sound-making device to make the first noise reduction sound wave according to the corresponding sound wave information, so that the noise sound wave made by the noise source and the first noise reduction sound wave are superimposed, thereby reducing noise.

In this way, the two sound waves having an equal frequency, an equal amplitude, and a reverse phase may cancel each other during superimposition, thereby achieving the function of reducing sound wave strength.

The noise source may be a fan set inside an electronic device and used to perform cooling treatment for the electronic device. The sound-making device may be a device that is capable of making sound waves, such as, a loudspeaker or a speaker box.

Optionally, in a possible implementation manner of this embodiment, after the instructing unit 23 instructs the sound-making device to make the first noise reduction sound wave according to the corresponding sound wave information, the obtaining unit 21 may further obtain the superimposed sound wave information after the noise sound wave made by the noise source and the first noise reduction sound wave are superimposed, and transmit the superimposed sound wave information to the determining unit 22; correspondingly, the determining unit 22 may further adjust the corresponding sound wave information according to the superimposed sound wave information, and transmit the adjusted corresponding sound wave information to the instructing unit 23, where the adjusted corresponding sound wave information is used to instruct the sound-making device to make a second noise reduction sound wave having an equal frequency, an equal amplitude, and a reverse phase of the noise sound wave made by the noise source in the operating condition; and the instructing unit 23 may further instruct the sound-making device to make the second noise reduction sound wave according to the adjusted corresponding sound wave information, so that the noise sound wave made by the noise source and the second noise reduction sound wave are superimposed, thereby further reducing noise.

Optionally, in a possible implementation manner of this embodiment, if the noise source is a fan, then, accordingly, the obtaining unit 21 may specifically obtain a rotation speed of the fan and a pressure difference caused by the fan; or may also obtain a rotation speed of the fan and a current of the fan, which is not limited in this embodiment.

Optionally, in a possible implementation manner of this embodiment, the corresponding sound wave information determined by the determining unit 22 may include a frequency, an amplitude, and a phase of the first noise reduction sound wave required to be made.

Optionally, in a possible implementation manner of this embodiment, the corresponding sound wave information determined by the determining unit 22 may be direct indication information, used to directly instruct the sound-making device to make the first noise reduction sound wave having an equal frequency, an equal amplitude, and a reverse phase of the noise sound wave made by the noise source.

Optionally, in a possible implementation manner of this embodiment, the corresponding sound wave information determined by the determining unit 22 may also be indirect indication information, used to instruct the sound-making device to make the first noise reduction sound wave having an equal frequency, an equal amplitude, and a reverse phase of the noise sound wave made by the noise source after conversion.

Optionally, in a possible implementation manner of this embodiment, before the determining unit 22 determines the sound wave information corresponding to the operating condition information according to the pre-set mapping between the operating condition information and the sound wave information, the obtaining unit 21 may further obtain the mapping between the operating condition information and the sound wave information through test, as shown in Table 1, and transmit the mapping between the operating condition information and the sound wave information to the determining unit 22.

In this embodiment, the noise reduction device obtains the operating condition information of the noise source through the obtaining unit, where the operating condition information represents the operating condition of the noise source, then determines the sound wave information corresponding to the obtained operating condition information according to the pre-set mapping between the operating condition information and the sound wave information through the determining unit, so that the instructing unit may instruct the sound-making device to make the first noise reduction sound wave having an equal frequency, an equal amplitude, and a reverse phase of the noise sound wave made by the noise source in the operating condition, and active noise reduction is performed. Steps such as collection, conversion, and calculation for noise generated by the noise source are not required, thereby shortening time for the active noise reduction, and reducing noise reduction space. In addition, the controller does not need to perform complicated calculating operations, thereby effectively lowering performance requirements for the controller.

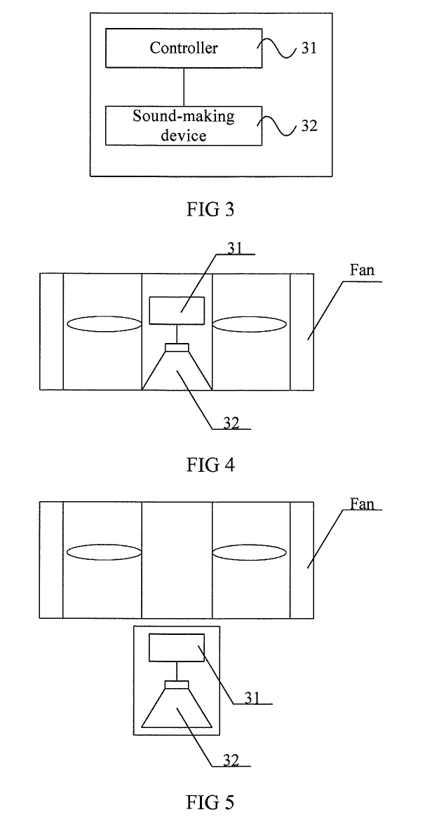

FIG. 3 is a schematic structural diagram of a noise reduction system according to another embodiment of the present application. As shown in FIG. 3, the noise reduction system in this embodiment may include a controller 31 and a sound-making device 32.

The controller 31 is configured to obtain operating condition information of a noise source, where the operating condition information represents an operating condition of the noise source, and to determine sound wave information corresponding to the obtained operating condition information according to a pre-set mapping between the operating condition information and the sound wave information, where the corresponding sound wave information is used to instruct a sound-making device to make a first noise reduction sound wave having an equal frequency, an equal amplitude, and a reverse phase of a noise sound wave made by the noise source in the operating condition.

The controller 31 is further configured to send a first sound-making command to the sound-making device 32 according to the corresponding sound wave information, where the first sound-making command is used to instruct the sound-making device to make the first noise reduction sound wave.

The sound-making device 32 is connected with the controller 31, and is configured to receive the first sound-making command, and to make the first noise reduction sound wave according to the first sound-making command, so that the noise sound wave made by the noise source and the first noise reduction sound wave are superimposed, thereby reducing noise.

In this way, the two sound waves having an equal frequency, an equal amplitude, and a reverse phase may cancel each other during superimposition, thereby achieving the function of reducing sound wave strength.

The noise source may be a fan set inside an electronic device and used to perform cooling treatment for the electronic device. The sound-making device 32 may be a device that is capable of making sound waves, such as, a loudspeaker or a speaker box.

Optionally, in a possible implementation manner of this embodiment, the controller 31 and the sound-making device 32 in this embodiment are connected in a wired manner.

Optionally, in a possible implementation manner of this embodiment, the controller 31 and the sound-making device 32 in this embodiment are connected in a wireless manner.

It is understandable that, the controller 31 and the sound-making device 32 may be independently set, or may also be integrated to form a unity.

Optionally, in a possible implementation manner of this embodiment, the controller 31 and the sound-making device 32 may be set inside the noise source (such as a fan), as shown in FIG. 4.

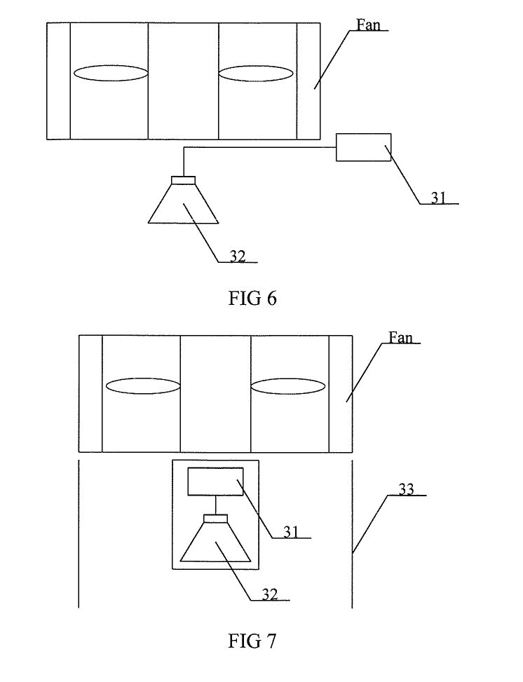

Optionally, in a possible implementation manner of this embodiment, the controller 31 and the sound-making device 32 may be set outside the noise source (such as a fan), as shown in FIG. 5 (the controller 31 and the sound-making device 32 are integrated to form a unity) and FIG. 6 (the controller 31 and the sound-making device 32 are independently set).

Optionally, in a possible implementation manner of this embodiment, after the controller 31 sends the first sound-making command to the sound-making device 32 according to the corresponding sound wave information,

the controller 31 may further obtain the superimposed sound wave information after the noise sound wave made by the noise source and the first noise reduction sound wave are superimposed, adjust the corresponding sound wave information according to the superimposed sound wave information, where the adjusted corresponding sound wave information is used to instruct the sound-making device 32 to make a second noise reduction sound wave having an equal frequency, an equal amplitude, and a reverse phase of the noise sound wave made by the noise source in the operating condition, and send a second sound-making command to the sound-making device 32 according to the adjusted corresponding sound wave information, where the second sound-making command is used to instruct the sound-making device 32 to make the second noise reduction sound wave; and

the sound-making device 32 may further receive the second sound-making command, and make the second noise reduction sound wave according to the second sound-making command, so that the noise sound wave made by the noise source and the second noise reduction sound wave are superimposed, thereby reducing noise.

Specifically, the controller 31 may collect the superimposed sound wave after superimposition through a sound collecting device, such as a microphone or a sound sensor, and then convert the superimposed sound wave into electrical signals to be transmitted to the controller 31, so that the controller 31 obtains the superimposed sound wave information after superimposition.

Optionally, in a possible implementation manner of this embodiment, if the noise source is a fan, then the controller 31 may specifically obtain a rotation speed of the fan and a pressure difference caused by the fan, or may also obtain a rotation speed of the fan and a current of the fan, which is not limited in this embodiment.

Optionally, in a possible implementation manner of this embodiment, the corresponding sound wave information determined by the controller 31 may include a frequency, an amplitude, and a phase of the noise reduction sound wave required to be made.

Optionally, in a possible implementation manner of this embodiment, the corresponding sound wave information determined by the controller 31 maybe direct indication information, used to directly instruct the sound-making device 32 to make the first noise reduction sound wave having an equal frequency, an equal amplitude, and a reverse phase of the noise sound wave made by the noise source.

Optionally, in a possible implementation manner of this embodiment, the corresponding sound wave information determined by the controller 31 may also be indirect indication information, used to directly instruct the sound-making device 32 to make the first noise reduction sound wave having an equal frequency, an equal amplitude, and a reverse phase of the noise sound wave made by the noise source after conversion.

Optionally, in a possible implementation manner of this embodiment, before the controller 31 determines the sound wave information corresponding to the operating condition information according to the pre-set mapping between the operating condition information and the sound wave information, the controller 31 may further obtain the mapping between the operating condition information and the sound wave information through test, as shown in Table 1.

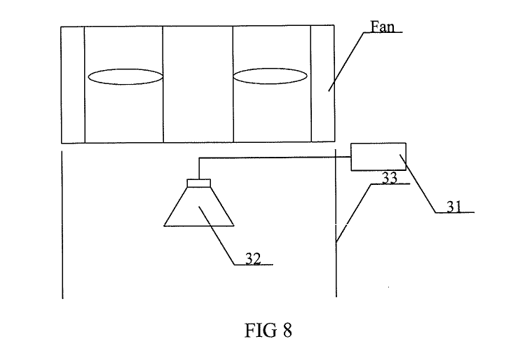

Optionally, in a possible implementation manner of this embodiment, as shown in FIG. 7 (the controller 31 and the sound-making device 32 are integrated to form a unity) and FIG. 8 (the controller 31 and the sound-making device 32 are independently set), the noise reduction system in this embodiment may further include a passage 33, set in a sound wave transfer path of the sound-making device 32, so that the superimposition of the noise sound wave made by the noise source and the first noise reduction sound wave or the second noise reduction sound wave is called plane wave superimposition, thereby effectively enhancing a noise reduction effect.

In this embodiment, the operating condition information of the noise source is obtained through the controller, where the operating condition information represents an operating condition of the noise source, then the sound wave information corresponding to the obtained operating condition information is determined according to the pre-set mapping between the operating condition information and the sound wave information, so as to enable the controller to perform active noise reduction by using the corresponding sound wave information. Steps such as collection, conversion, and calculation for noise generated by the noise source are not required, thereby shortening time for the active noise reduction, reducing noise reduction space and facilitating miniaturization of the device where the noise source is located. In addition, the controller does not need to perform complicated calculating operations, thereby effectively lowering performance requirements for the controller.

It may be clearly understood by persons skilled in the art that, for the purpose of convenient and brief description, for a detailed working process of the foregoing system, apparatus and unit, reference may be made to the corresponding process in the method embodiments, and the details will not be described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

In addition, functional units in the embodiments of the present application may be integrated into one processing unit, or each of the units may exist alone physically, or two or more units are integrated into one unit. The integrated unit may be implemented through hardware, or may also be implemented in a form of hardware plus a software functional module.

The integrated unit implemented in the form of software functional unit may be stored in a computer readable storage medium. The software functional unit is stored in a storage medium, and contains several instructions used to instruct computer equipment (for example, a personal computer, a server, or network equipment) to perform the steps of the methods in the embodiments of the present application. The foregoing storage medium includes: any medium that can store program codes, such as a USB flash disk, a removable hard disk, a read-only memory (ROM, Read-Only memory), a random access memory (RAM, Random Access Memory), a magnetic disk, or an optical disk.

Finally, it should be noted that the foregoing embodiments are merely provided for describing the technical solutions in the present application, but are not intended to limit the present application. It should be understood by persons of ordinary skill in the art that although the present application has been described in detail with reference to the embodiments, modifications can be made to the technical solutions described in the embodiments, or equivalent replacements can be made to some technical features in the technical solutions, as long as such modifications or replacements do not cause the essence of corresponding technical solutions to depart from the spirit and scope of the present application.

What is claimed is:

1. A noise reduction method, comprising:
obtaining operating condition information of a noise source, wherein the operating condition information represents an operating condition of the noise source;
determining sound wave information corresponding to the obtained operating condition information according to a pre-set mapping between the operating condition information and the sound wave information, wherein the corresponding sound wave information is used to instruct a sound-making device to make a first noise reduction sound wave having an equal frequency, an equal amplitude, and a reverse phase of a noise sound wave made by the noise source in the operating condition; and
instructing the sound-making device to make the first noise reduction sound wave according to the corresponding sound wave information, so that the noise sound wave made by the noise source and the first noise reduction sound wave are superimposed, thereby reducing noise.

2. The method according to claim 1, wherein after the instructing the sound-making device to make the first noise reduction sound wave according to the corresponding sound wave information, further comprising:
obtaining superimposed sound wave information after the noise sound wave made by the noise source and the first noise reduction sound wave are superimposed;
adjusting the corresponding sound wave information according to the superimposed sound wave information, wherein the adjusted corresponding sound wave information is used to instruct the sound-making device to make a second noise reduction sound wave having an equal frequency, an equal amplitude, and a reverse phase of the noise sound wave made by the noise source in the operating condition; and
instructing the sound-making device to make the second noise reduction sound wave according to the adjusted corresponding sound wave information, so that the noise sound wave made by the noise source and the second noise reduction sound wave are superimposed, thereby further reducing noise.

3. The method according to claim 1, wherein the noise source is a fan, and the obtaining the operating condition information of the noise source comprises:
obtaining a rotation speed of the fan and a pressure difference caused by the fan; or
obtaining a rotation speed of the fan and a current of the fan.

4. The method according to claim 1, wherein the corresponding sound wave information comprises:
a frequency, an amplitude, and a phase of the first noise reduction sound wave required to be made.

5. The method according to claim 1, wherein
the corresponding sound wave information is direct indication information, used to directly instruct the sound-making device to make the first noise reduction sound wave having an equal frequency, an equal amplitude, and a reverse phase of the noise sound wave made by the noise source; or
the corresponding sound wave information is indirect indication information, used to instruct the sound-making device to make the first noise reduction sound wave having an equal frequency, an equal amplitude, and a reverse phase of the noise sound wave made by the noise source after conversion.

6. The method according to claim 1, before the determining sound wave information corresponding to the obtained operating condition information according to a pre-set mapping between the operating condition information and the sound wave information, further comprising:
obtaining the mapping between the operating condition information and the sound wave information through test.

7. A noise reduction device, comprising:
an obtaining unit, configured to obtain operating condition information of a noise source, wherein the operating condition information represents an operating condition of the noise source, and to transmit the obtained operating condition information to a determining unit;
the determining unit, configured to determine sound wave information corresponding to the operating condition information according to a pre-set mapping between the operating condition information and the sound wave information, and to transmit the corresponding sound wave information to an instructing unit, wherein the corresponding sound wave information is used to instruct a sound-making device to make a first noise reduction sound wave having an equal frequency, an equal amplitude, and a reverse phase of a noise sound wave made by the noise source in the operating condition; and
the instructing unit, configured to instruct the sound-making device to make the first noise reduction sound wave according to the corresponding sound wave information, so that the noise sound wave made by the noise source and the first noise reduction sound wave are superimposed, thereby reducing noise.

8. The device according to claim 7, wherein after the instructing unit instructs the sound-making device to make the first noise reduction sound wave according to the corresponding sound wave information,
the obtaining unit is further configured to obtain the superimposed sound wave information after the noise sound wave made by the noise source and the first noise reduction sound wave are superimposed, and to transmit the superimposed sound wave information to the determining unit;
the determining unit is further configured to adjust the corresponding sound wave information according to the superimposed sound wave information, and to transmit the adjusted corresponding sound wave information to the instructing unit, wherein the adjusted corresponding sound wave information is used to instruct the sound-making device to make a second noise reduction sound wave having an equal frequency, an equal amplitude, and a reverse phase of the noise sound wave made by the noise source in the operating condition; and
the instructing unit is further configured to instruct the sound-making device to make the second noise reduction sound wave according to the adjusted corresponding sound wave information, so that the noise sound wave made by the noise source and the second noise reduction sound wave are superimposed, thereby further reducing noise.

9. The device according to claim 7, wherein the noise source is a fan, and the obtaining unit is specifically configured to
obtain a rotation speed of the fan and a pressure difference caused by the fan; or
obtain a rotation speed of the fan and a current of the fan.

10. The device according to claim 7, wherein the corresponding sound wave information determined by the determining unit comprises:
a frequency, an amplitude, and a phase of the first noise reduction sound wave required to be made.

11. The device according to claim 7, wherein
the corresponding sound wave information determined by the determining unit is direct indication information, used to directly instruct the sound-making device to make the first noise reduction sound wave having an equal frequency, an equal amplitude, and a reverse phase of the noise sound wave made by the noise source; or
the corresponding sound wave information determined by the determining unit is indirect indication information, used to instruct the sound-making device to make the first noise reduction sound wave having an equal frequency, an equal amplitude, and a reverse phase of the noise sound wave made by the noise source after conversion.

12. The device according to claim 7, wherein before the determining unit determines the sound wave information corresponding to the operating condition information according to the pre-set mapping between the operating condition information and the sound wave information, the obtaining unit is further configured to
obtain the mapping between the operating condition information and the sound wave information through test, and transmit the mapping between the operating condition information and the sound wave information to the determining unit.

13. A noise reduction system, comprising a controller and a sound-making device, wherein
the controller is configured to obtain operating condition information of a noise source, wherein the operating condition information represents an operating condition of the noise source, and to determine sound wave information corresponding to the obtained operating condition information according to a pre-set mapping between the operating condition information and the sound wave information, wherein the corresponding sound wave information is used to instruct a sound-making device to make a first noise reduction sound wave having an equal frequency, an equal amplitude, and a reverse phase of a noise sound wave made by the noise source in the operating condition;
the controller is further configured to send a first sound-making command to the sound-making device according to the corresponding sound wave information, wherein the first sound-making command is used to instruct the sound-making device to make the first noise reduction sound wave; and
the sound-making device is connected with the controller, and is configured to receive the first sound-making command, and to make the first noise reduction sound wave according to the first sound-making command, so that the noise sound wave made by the noise source and the first noise reduction sound wave are superimposed, thereby reducing noise.

14. The system according to claim 13, wherein after the controller sends the first sound-making command to the sound-making device according to the corresponding sound wave information,
the controller is further configured to obtain the superimposed sound wave information after the noise sound wave made by the noise source and the first noise reduction sound wave are superimposed, to adjust the corresponding sound wave information according to the superimposed sound wave information, wherein the adjusted corresponding sound wave information is used to instruct the sound-making device to make a second noise reduction sound wave having an equal frequency, an equal amplitude, and a reverse phase of the noise sound wave made by the noise source in the operating condition, and to send a second sound-making command to the sound-making device according to the adjusted corresponding soundwave information, wherein the second sound-making command is used to instruct the sound-making device to make the second noise reduction sound wave; and
the sound-making device is further configured to receive the second sound-making command, and to make the second noise reduction sound wave according to the second sound-making command, so that the noise sound wave made by the noise source and the second noise reduction sound wave are superimposed, thereby reducing noise.

15. The system according to claim 13, wherein the noise source is a fan, and the controller is specifically configured to
obtain a rotation speed of the fan and a pressure difference caused by the fan; or
obtain a rotation speed of the fan and a current of the fan.

16. The system according to claim 13, wherein the corresponding sound wave information determined by the controller comprises:
a frequency, an amplitude, and a phase of the noise reduction sound wave required to be made.

17. The system according to claim 13, wherein
the corresponding sound wave information determined by the controller is direct indication information, used to directly instruct the sound-making device to make the first noise reduction sound wave having an equal frequency, an equal amplitude, and a reverse phase of the noise sound wave made by the noise source; or
the corresponding sound wave information determined by the controller is indirect indication information, used to directly instruct the sound-making device to make the first noise reduction sound wave having an equal frequency, an equal amplitude, and a reverse phase of the noise sound wave made by the noise source after conversion.

18. The system according to claim 13, wherein before the controller determines the sound wave information corresponding to the operating condition information according to the pre-set mapping between the operating condition information and the sound wave information, the controller is further configured to
obtain the mapping between the operating condition information and the sound wave information through test.
